(19) United States
(12) Patent Application Publication
(10) Pub. No.: US 2013/0137057 A1
(43) Pub. Date: May 30, 2013

(54) CARRIER FOR DENTAL IMPRESSION COMPOUND

(71) Applicant: Medentic S.A., Wasserbillig (LU)

(72) Inventor: Fritz Schmitt, Wasserbillig (LU)

(73) Assignee: Medentic S.A., Wasserbillig (LU)

(21) Appl. No.: 13/747,420

(22) Filed: Jan. 22, 2013

Related U.S. Application Data
(63) Continuation of application No. PCT/EP2011/062462, filed on Jul. 20, 2011.

(30) Foreign Application Priority Data
Jul. 20, 2010 (DE) DE 102010032332.2

(51) Int. Cl. A61C 9/00

(52) U.S. Cl. CPC A61C 9/0053
USPC 433/29

(57) ABSTRACT

The invention relates to a carrier for a dental impression material for insertion into an impression tray or attachment to a holding device, having a base area which replicates the human jaw and is delimited on two opposing sides by walls in order to form an approximately U-shaped cross section, wherein at least one optical element is arranged in the base area and/or the walls.

### CROSS REFERENCES TO RELATED APPLICATIONS

This application is a continuation of international patent application PCT/EP2011/062462, filed on Jul. 20, 2011, designating U.S., which international patent application has been published in German language and claims priority from German patent application DE 10 2010 032 332.2, filed on Jul. 20, 2010. The entire contents of these priority applications are incorporated herein by reference.

### BACKGROUND OF THE INVENTION

The present invention relates to a carrier for a dental impression material for insertion into an impression tray or attachment to a holding device, having a base area which replicates the human jaw and is delimited on two opposing sides by walls in order to form an approximately U-shaped cross section.

Carriers of this type are generally known in the field of dentistry. There, they are used, in particular, for holding impression materials for taking an impression of the dentition of a patient. To this end, an appropriate dental impression material is filled into the carrier, into which the dentition of the patient is pressed. After the impression material has cured, a corresponding negative of the dentition of the patient is initially available. Then, by filling with plaster, this is converted into corresponding plaster models to form a positive. This positive can then be used by the dental technician to manufacture, for example, the corresponding tooth replacement or the corresponding inlays.

As a result of the fact that the production of e.g. a tooth replacement takes place on the basis of a cast of an impression, the accuracy with which, for example, the tooth replacement can be manufactured is necessarily limited. In order to solve this problem, recent times have often seen the proposition of digital systems based on cameras in the field of dentistry, which digital systems should serve to capture one or more teeth or a whole jaw arch and to reproduce this in the form of digital data. By way of example, an implant can then be made on the basis of this data.

Even though a certain amount of success was obtained up until now by using such techniques, it was found that these techniques also do not yet supply optimal results as a result of shadows being cast in particular, and also as a result of insufficient illumination of specific regions.

In order to solve these problems, the present applicant has developed a method which is based on a combination of a measurement method on an optical basis and the use of specific impression materials. Generally speaking, impressions are taken using luminescent impression materials and then measured by means of optical methods. By way of example, this method is described in the yet to be laid-open application PCT/EP2009/006474, the entirety of which is incorporated herein by reference.

In this method, in addition to using a luminescent impression material, it is furthermore indispensable for exact measurement results that the compound also has an always uniform distribution in the impression tray and is completely free of even small bubbles of air or other impurities and inclusions. Such irregularities would otherwise during the measurement method lead to inaccuracies and errors in the digital data of the dentition of the patient, which ultimately propagate right up to the manufacturing of the prosthesis and could, in individual cases, lead to a tooth replacement that cannot be used, for example.

It is standard practice for the impression materials to be filled into the carriers or impression trays by the dentist or their assistant, using the conventional aids found in the laboratory. In the process, it is very difficult if not even impossible to guarantee constant uniform filling of the compound and the necessary absence of bubbles. Since small bubbles in particular can often not be identified by the naked eye either, this cannot, in general, be avoided or monitored either on the part of the treating dentist. For long-term quality control, pre-manufacturing of the impression material in a carrier of the type mentioned at the outset would be feasible. In the process, the aforementioned errors could be largely excluded or avoided by machine processes. However, this is out of the question for currently known carriers because these do not have the corresponding properties so that these can be used to perform or are able to perform the corresponding sensor-assisted measurements.

The present invention is therefore based on the object of developing a carrier of the type mentioned at the outset such that it is suitable for use with the corresponding aforementioned impression materials and can be used for the above-described measurement method.

### SUMMARY OF THE INVENTION

According to the invention, this object is achieved by virtue of the fact that at least one optical element is arranged in the base area and/or the walls, preferably that a multiplicity of optical elements are arranged in the base area and/or the walls and, in particular, that the optical elements are selected from lenses, optical fibers, filters and combinations thereof.

This embodiment is advantageous in that the use of the appropriate optical elements, such as e.g. lenses, optical fibers, filters and combinations thereof, renders it possible that light information can pass through the base area and/or the walls of the carrier without significant losses. Hence such a carrier can be used with corresponding impression trays, which are equipped with light sources and/or sensors. Here, the carrier can, in principle, be considered as a highly transparent object which is suitable for the described measurement method. Other possibilities could consist of the fact that, for example, if optical fibers are used, these could be routed to a specific collection point. In the latter case, an appropriate coupling would then have to be provided on the impression tray, by means of which coupling the collected light information can be transmitted.

Within the scope of the invention, a base area which replicates the jaw should be understood to mean that the part of the base area which is delimited by the walls replicates the human jaw, i.e. is roughly speaking U-shaped. Going beyond this, the base area can have any shape provided that it can be inserted into an impression tray. In addition to the pure U-shape, an embodiment in the form of half an ellipse is hereby an obvious shape for the carrier.

In a further embodiment, the optical elements furthermore comprise electronic sensors, with the carrier preferably comprising at least one plug-in connection for transmitting data to a storage unit or a processing unit.

As a result of using electronic sensors within the carrier, the optical information can be immediately converted into digital information by the electronic sensors in the carrier. As a result, the susceptibility to errors in the transmission of information from the impression material to the impression tray is once again reduced because this does not take place in the form of light information, but rather in the form of less susceptible digital information. To this end, the electronic sensors can then via e.g. one or more plug-in connections be connected to corresponding storage units and/or image or data processing systems (processing units). These can be arranged in the carrier itself, or else in the impression tray. Particularly for the latter variant, provision must then be made for an appropriate connection in the form of at least one connector, e.g. a plug-in connection, to the impression tray for the purpose of transmitting the data.

In a further embodiment of the invention, at least one illumination means is arranged in the base area and/or the walls.

For the purpose of recording the corresponding data as per the above-described measurement method, it is necessary for light to be irradiated into the impression material in advance, for example for generating fluorescence or phosphorescence. In the novel method, this until now occurs as a standard by illumination means in the impression tray.

Compared to this, the aforementioned embodiment is advantageous in that the light from the illumination means no longer has to pass through the carrier and therefore cannot be additionally attenuated. There is therefore direct illumination of the impression material and, as a result thereof, of the teeth to be measured.

In a further embodiment of the invention, the at least one illumination means is selected from chemiluminescent elements, LEDs, OLEDs, laser LEDs and combinations thereof.

The use of these compared to incandescent illuminants of more developed illumination means has the significant advantage that, firstly, they require less space and, secondly, they develop significantly less heat. Furthermore, such illumination means can also be matched more easily to corresponding shapes, such as e.g. the shape of the carrier. Nevertheless, these generally have high luminous intensity.

In a further embodiment of the invention, the carrier has a surface on the inner side thereof, which exhibits increased adherence compared to silicones.

An advantage of this is that impression materials on the basis of silicone adhere better to the carrier and do not detach from the carrier, for example when the carrier is pulled away from the dentition for correction purposes—the latter could, for example, lead to the formation of bubbles and the imaging errors connected therewith.

In a further embodiment of the invention, the carrier consists of an acrylate polymer, preferably polymethyl methacrylate.

The use of acrylate polymers, more particularly of polymethyl methacrylate (PMMA), is advantageous in that the carrier is already better suited to the optical methods on account of the transparency of the plastic. Moreover, PMMA, for example, is non-toxic and has been established in medicine for years.

In a further embodiment of the invention, the carrier is embodied as an injection-molded part.

An advantage of this is that the carrier can easily be made in an injection molding method. As a result, industrial automated production of the carriers is possible.

In a further embodiment of the invention, the carrier comprises fastening means for fastening to an impression tray.

The embodiment with fastening means has the advantage that the carrier can be arranged on the impression tray in a secure and immovable fashion. This is necessary for the impression procedure in particular since the forces on the carrier occurring in the process could otherwise easily lead to slippage. This would inevitably once again lead to errors in the measurement procedure. Furthermore, the fastening means also render it possible to ensure that the carriers are always inserted into the impression tray in the same position.

In a further embodiment of the invention, the base area and/or the side walls are at least partly mirrored on the inner side, with the at least one optical element not being mirrored.

An advantage of this embodiment is that light, once it has entered the space between carrier and dentition, in which the impression material is situated, cannot simply exit through the walls of the carrier again, or is absorbed by the latter. Hence this embodiment contributes to the brightness in the gap between carrier and dentition. This in turn increases the measurement accuracy as a result of the higher light intensity. The mirroring of the at least one optical element must thereby be prevented because otherwise the use thereof for recording the optical information is hindered or rendered impossible.

In a further embodiment of the invention, the carrier furthermore comprises a dental impression material, which is at least partly filled into the space defined by the walls and the base area, with the impression material preferably comprising at least one luminescent material.

This embodiment is advantageous in that the carrier is thus already supplied with the ready dental impression material to the dentist or dental technician, and so they do not have to be entrusted with the filling process themselves. Hence the combination of carrier and compound can be supplied as a finished pre-produced part, with a uniform distribution of the compound and the freedom from unwanted inclusions, such as e.g. air, being ensured.

In a further embodiment of the invention, the impression material is a curable impression material.

The use of a curable impression material is advantageous in that this also allows the provision of a physical impression, for study purposes, to a dentist or dental technician after the compound has cured, in addition to the digital data.

In an embodiment of the aforementioned measure, the impression material is at least partly cured in the region of the walls.

An advantage of this embodiment is that this can prevent a patient from biting through the base plate when the impression is taken since this can have an adverse effect on the measurement. Furthermore, this measure can ensure uniform spacing of the jaw arch from the wall, which in turn improves the measurement accuracy.

In a further embodiment of the invention, the carrier is designed for single use.

The single use is advantageous in that the carrier, optionally with the already filled dental impression material, can be supplied to the customer, i.e. the dentist or dental technician; the latter uses, according to the invention, the corresponding carrier together with an impression tray in the measurement method and can subsequently simply dispose of the carrier which was in the interior of the mouth of the patient. This dispenses with cleaning and sterilization steps for the carriers, which steps would otherwise be necessary and which are connected to effort and costs. However, within the scope of this invention, single use can, in addition to the disposal, also be understood to mean a return to the producer or supplier. The latter would then let the carriers be cleaned and sterilized on an industrial scale and, within the scope of a recycling process, refill the carriers with impression material and deliver them to the customers. Here, appropriate marking of the carriers, e.g. by bar codes, digital data such as chips, or simple engraving, can then for example ensure that excessive re-use does not happen and that a carrier only runs through the desired number of uses. This method would be particularly expedient for those carriers that are equipped with further cost-intensive technology, such as sensors.

It is understood that the aforementioned features and those yet to be explained below can be used not only in the respectively specified combination, but also in other combinations or on their own, without departing from the scope of the present invention.

The invention will, in conjunction with the attached drawings, be described and explained in more detail below on the basis of selected exemplary embodiments. In detail:

### BRIEF DESCRIPTION OF THE DRAWINGS

FIG. 1 shows a perspective illustration of an embodiment of a carrier according to the invention,

FIG. 2 shows a perspective illustration of a further embodiment of a carrier according to the invention,

FIG. 3 shows a perspective illustration of an impression tray which is suitable for holding a carrier according to the invention,

FIG. 4 shows a perspective illustration of the impression tray from FIG. 3 with an inserted carrier in accordance with the illustration of FIG. 1,

FIG. 5 shows a perspective side view of an impression tray from FIG. 3 with two carriers according to the invention held therein, corresponding to the illustration of FIG. 1 for upper and lower jaw,

FIG. 6 shows a perspective illustration of the carrier from FIG. 1 with dental impression material held therein,

FIGS. 7A to 7C show perspective illustrations of carriers according to the invention in accordance with FIG. 1, with schematically illustrated optical elements respectively being arranged in different regions: in the base area in FIG. 7A, continuously in or on both sides of the walls in FIG. 7B and in the walls on the inner side facing the dentition in FIG. 7C,

FIG. 8 shows a sectionally perspective illustration of a further embodiment of a carrier according to the invention, which is arranged at one end of an impression tray and additionally has illumination means in the base area thereof, and

### DESCRIPTION OF PREFERRED EMBODIMENTS

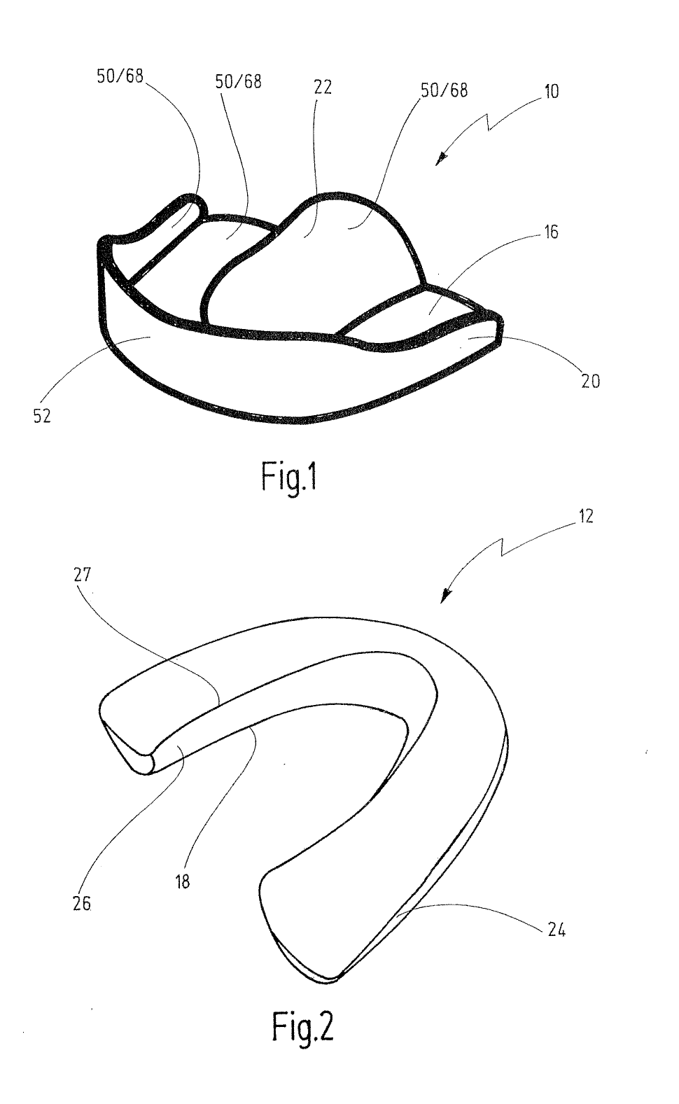

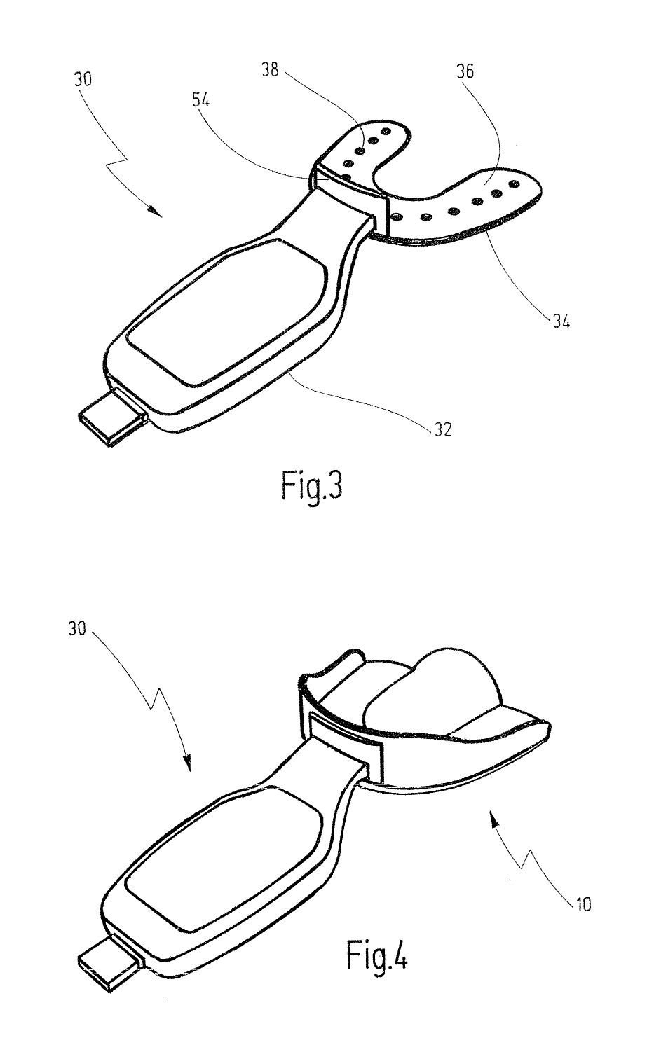

A carrier according to the invention illustrated in FIGS. 1 and 4 to 7 is denoted in its entirety by reference sign 10, while a carrier illustrated in FIGS. 2 and 3 has the reference sign 12 and the carrier illustrated in FIG. 8 has the reference sign 14.

The carriers 10 and 12 illustrated in FIGS. 1 and 2 represent two main exemplary embodiments of the carriers according to the invention. Both carriers 10 and 12 have a base area 16 and 18, respectively, which substantially replicates the shape of a human jaw. The base area 16 of the carrier 10 is laterally delimited to the outside with respect to a jaw by the wall 20 and to the inside by the wall 22. The carrier 12 from FIG. 2 correspondingly comprises the wall 24 toward the outside and the wall 26 toward the inside.

Here it is possible to see clearly the difference in the inwardly situated walls 22 and 26 between carrier 10 and carrier 12. While the wall 26 of the carrier 12 from FIG. 2 has a parallel profile with respect to the outwardly situated wall 24, which profile is embodied such that the teeth of the dentition to be surrounded are held as in a groove, the inwardly situated wall 22 of the carrier 10 from FIG. 1 is initially, proceeding from the base area 16, also embodied parallel to the outwardly situated wall 20 but, in the further extent, it is oriented parallel to the palate of the patient. Hence, with respect to FIG. 1, the inwardly situated wall 22 is upwardly closed, while the wall 26 finishes toward the top with an edge 27.

As a result of their embodiments with the base areas 16 and 18 and also the laterally delimiting walls 20 and 22 as well as 24 and 26, respectively, both carriers 10 and 12 have a U-shaped cross-sectional profile as seen perpendicularly to the arch-shaped profile of the respective base area 16 and 18, respectively.

These carriers 10 and 12 are used to take impressions of the human jaw in patients. To this end, they are provided with an impression material 28 which is described in more detail below in conjunction with FIG. 6 and which, for reasons of clarity, is not illustrated in FIGS. 1 to 5 and 7 and 8. Furthermore, to this end, the carrier 10 or 12 must be placed onto an impression tray 30 or inserted therein, as will be explained in more detail below on the basis of FIGS. 3 to 5.

In FIG. 3 the impression tray 30 is illustrated on its own. This impression tray 30 comprises a handle 32 and a holder 34, which serves to hold the carrier 10. In this exemplary embodiment of the impression tray 30, this holder 34 comprises an area 36 which is matched to the base area 16 of the carrier 10 and onto which this base area 16 can be placed. In order moreover to ensure a secure hold of the carrier 10 on the impression tray 30, the latter has additional fastening means on the holder 34. In the present exemplary embodiments, these fastening means are embodied as latching openings 38, into which corresponding latching pins (not shown in any more detail in this context) of the carrier 10 can be inserted.

However, instead of these latching openings 38 illustrated here in an exemplary fashion, all other conventional connection methods known from the prior art for a connection between holder 34 and carrier 10 which permit a correspondingly fast and comfortable connection between carrier and impression tray are also feasible. Tongue and groove, screw-in and magnetic connections or similar are mentioned here in an exemplary fashion.

A corresponding combination of inserted carrier 10 and impression tray 30 can be seen in FIG. 4.

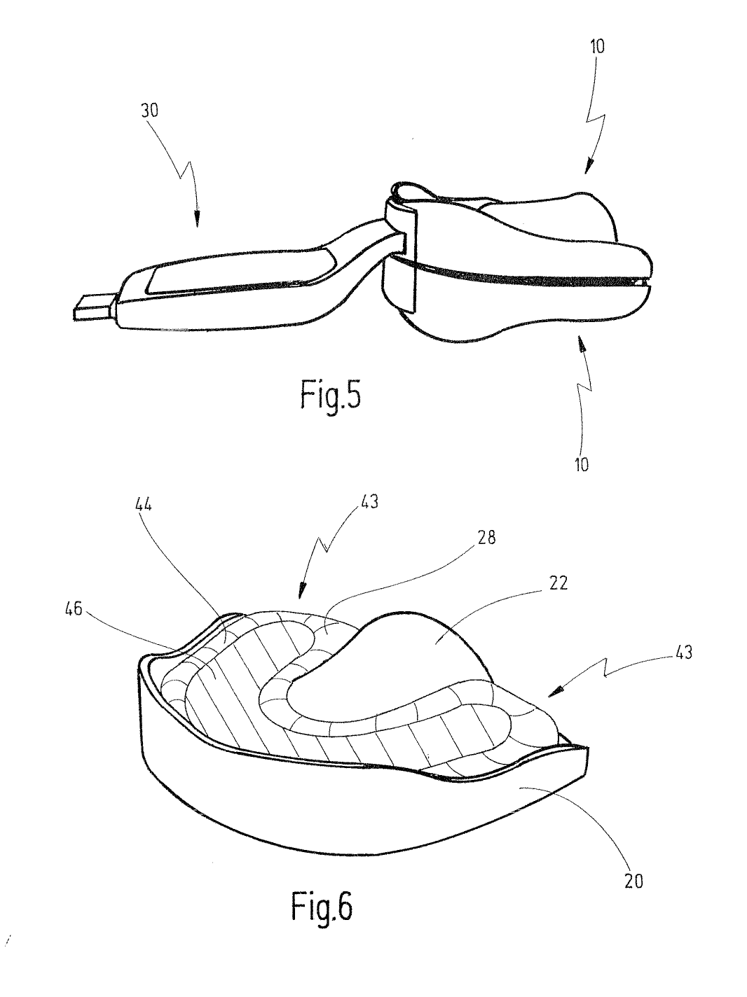

However, since this arrangement in accordance with FIG. 4 merely allows an impression to be taken of only one jaw of the patient, an alternative embodiment provides for the holder 34 to be allowed to hold a further carrier 10 on its opposite side. This is illustrated in FIG. 5. As a result, it is now possible to simultaneously make an impression of upper and lower jaw.

In the preceding figures, the already-mentioned impression material 28, and also the electronic sensors 42 and optical elements 40 according to the invention, were not illustrated for reasons of clarity.

Here the impression material 28 should initially be discussed in more detail on the basis of FIG. 6. Such an impression material 28 is preferably curable.

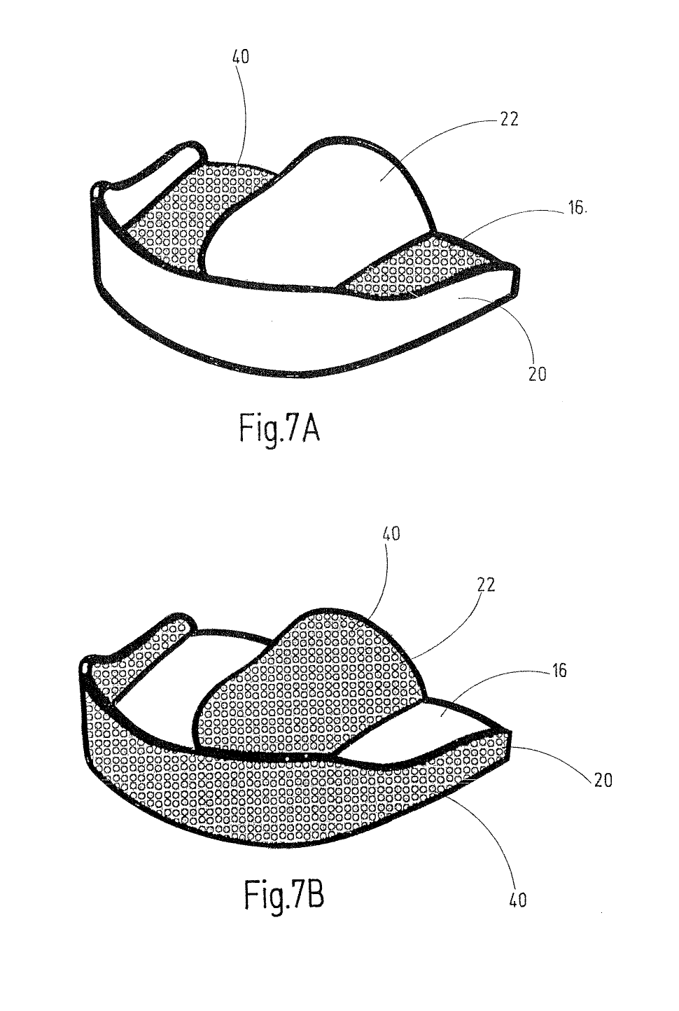

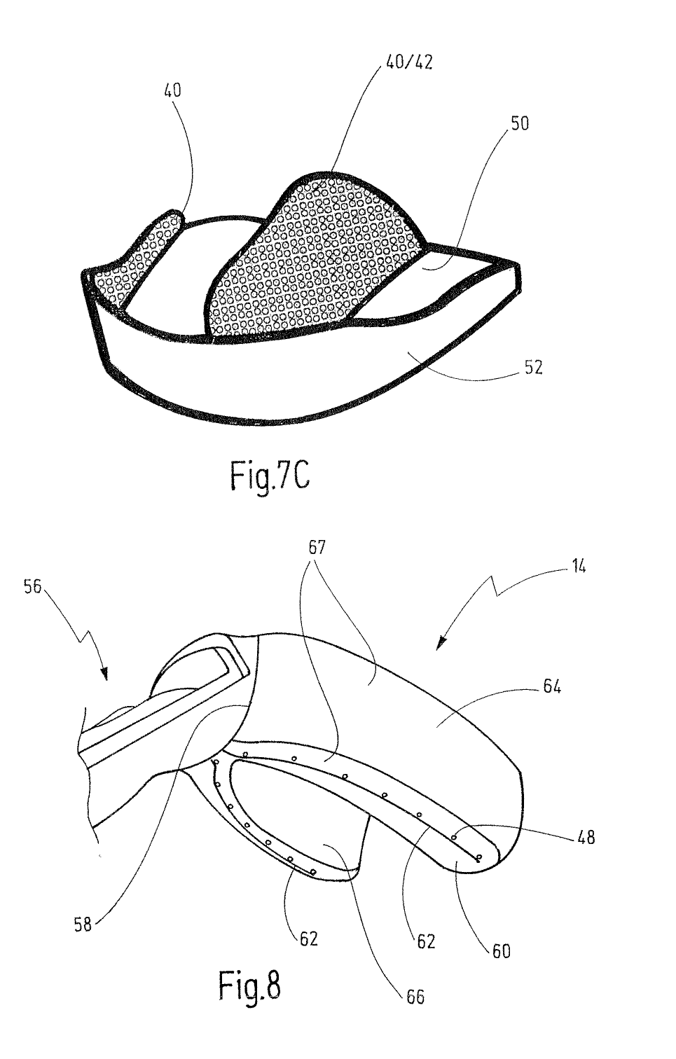

As already explained at the outset, the present invention is based on a measurement method which is based on interplay between electronic sensors 42, as will be described in more detail in conjunction with FIG. 7C, and a corresponding impression material 28.

In order to carry out the measurement method, the carrier 10 with the impression material 28 is inserted into a suitable impression tray, for example the impression tray 30. Since the carrier 10 is transparent in the present case, the impression tray 30 comprises illumination elements for illuminating the impression material, and optical sensors for measuring light emerging from the impression material. In order to measure e.g. a jaw, the impression tray illuminates the compound arranged in the carrier and causes the compound to phosphoresce, for example. The user then presses the teeth or the jaw to be measured into the impression material. The impression tray is then used to measure the light emerging from the impression material. Here the measured light can originate directly from the luminescence of the compound, with it being possible for the digitized model of the jaw to be determined via the specific luminescence, i.e. the light yield per unit volume. However, it is also feasible to measure the reflections on the structures to be measured in the form of image information, with the luminescent material leading to a particularly good illumination, and to calculate the digital model on the basis of the image information. Furthermore, the method can also be based on a combination of the aforementioned measurements.

Here, it is indispensable in this method for the impression material to be free from impurities or inclusions such as air, for example. Here, even the smallest air-bubble inclusions, which cannot be identified with the naked eye, are a potential cause of significant errors, which can lead to imprecision in the established data and hence also in the image of the dentition.

This is extremely undesirable because this can result in subsequent errors during the production of implants or prostheses, which leads to discomfort for the patient and may, for example, lead to an implant that cannot be used.

For the same reasons it is also important that the impression material 28 is introduced uniformly in the carrier 10 or 12, i.e. that this also reduces the imprecision during the measurement to a minimum.

Both can be reduced by virtue of the impression material 28 already being filled in a corresponding carrier 10 or 12 when it is supplied to the dentist or dental technician.

The impression material 28 is filled into a space 43 defined by the walls 20 and 22 and the base area 16 as can be seen from FIG. 6. It can thereby be seen from the differently shaded regions of the impression material 28 that the latter is subdivided into two regions in this preferred embodiment. These regions consist of an at least already partly cured region 44 and a non-cured or less cured region 46. The already at least partly cured region 44, which also extends along the base area 16 (which cannot be seen here), prevents the patient from being able to bring their teeth as far as the base area 16 or onto the inwardly situated walls 22 or outwardly situated walls 20 when the patient presses their jaw into the impression material 28.

This is necessary in particular when use is made of the corresponding impression material 28 with the preferred fluorescing or phosphorescing materials. This is due to the fact that, as already described above, the amount of light which is re-emitted by the impression material 28 after corresponding irradiation is used to determine a distance. If no impression material 28 is present between the electronic sensors 42 and the teeth of the patient (not illustrated here), for example because the tooth of the patient lies directly on the base area 16, then it is not possible to determine a distance value in this case either. This leads to errors and, in particular, to imprecision when measuring the jaw of the patient.

However, if the at least partly cured region 44 is present, the tooth finally meets this region 44 after passing through the not yet cured region 46. The former region then prevents further penetration, for example up to the base area 16.

As already mentioned above, appropriate electronic sensors 42 are required for creating the image of the jaw. The sensors register light which originates from a reflection at the teeth or from the luminescent impression material already described above and is induced by light which is emitted by illumination means 48. These illumination means 48 will be described in more detail below.

In one embodiment, the electronic sensors 42 can already be present in impression trays 30, which is not illustrated in any more detail in the present figures.

For this case, the carriers 10 and 12 then have a multiplicity of corresponding optical elements 40, as are described in more detail in conjunction with FIGS. 7A and 7B. In a preferred embodiment of the present invention, these optical elements 40 can for example be lenses, optical fibers, filters or combinations of these. Depending on the type and use of the utilized electronic sensors 42, these optical elements can be arranged in such a way that, for example as shown in FIG. 7A, they are arranged in the base area 16 of a carrier 10. Here, the optical elements are illustrated schematically in FIG. 7 as circular objects.

A further option for arranging the optical elements 40 lies in merely arranging these in the walls 20 and/or 22. Here, FIG. 7B illustrates the embodiment in which the optical elements are present both in the outwardly lying wall 20 and in the inwardly lying wall 22.

In addition to the embodiments shown in FIGS. 7A and 7B, provision is naturally also made within the present invention for those embodiments in which the optical elements 40 are arranged both in the base area 16 and in the walls 20 and/or 22.

These aforementioned exemplary embodiments of the carriers 10 with the optical elements 40 provide for the light, which is irradiated between optical elements 40 and, for example, a tooth of the patient (not illustrated in any more detail here), after the above-described reflection, or for the luminescence light emitted by the impression material to be able to pass through the optical elements 40 without significant losses to the electronic sensors 42.

Additionally, in particular in the case of using optical fibers as optical elements 40, it is also feasible for a uniformly distributed arrangement of the optical elements 40 only to be present on an inner side 50 of the carrier 10, and for the corresponding entrance for the light to be formed as a result thereof. Compared to this, the exit, which is formed by the other end of the optical fibers, is embodied as at least an optical fiber bundle. This optical fiber bundle (not shown in any more detail here) can then be routed to corresponding electronic sensors 42. An illustration corresponding to this embodiment, in which merely the inner side 50 has been provided with identifiable optical elements 40 or the ends thereof, is illustrated in an exemplary fashion for the walls 20 and 22 in FIG. 7C. There it is possible to see that an outer side 52 lying opposite to the inner wall 50 does not comprise any ends of optical elements 40.

However, in contrast to the above-described exemplary embodiment, the electronic sensors 42 can also be arranged such that these electronic sensors are likewise contained in the carrier 10 or 12 and therefore form part of the optical elements 40.

A corresponding embodiment would then be designed like the one illustrated in exemplary fashion in FIG. 7C for the walls 20 and 22. In this case, the electronic sensors 42 could either be a multiplicity of individual sensors which are distributed on the inner side 50 at the desired points of the carrier 10. However, if use is made of optical fibers or else of lenses, an embodiment would also be feasible in which the optical elements 40 form at least one group, the optical information of which is conveyed to at least one common electronic sensor 42.

The exemplary embodiment in which the electronic sensors 42 are part of the optical elements 40 in the carrier 10 also differs from the aforementioned exemplary embodiment, in which the electronic sensors 42 are arranged at corresponding points in the impression tray 30, by virtue of the transmission of the collected data.

In the first-mentioned exemplary embodiment, the data are initially transmitted through light connectors still in the form of the corresponding light, while in the second embodiment the data are transmitted already in the form of digital data. Depending on the type of the electronic sensor 42, this data could also already be processed at least to a certain extent.

Here the second embodiment is preferred in view of the data transmission because, in addition to a simpler data-transmission connector between carrier 10 and impression tray 30, this digital data transmission is also less susceptible to errors.

The connector not shown in any more detail here for transmitting the optical or digital data can, for example, be arranged in the front 54, visible in FIG. 3, at the end of the area 36 on the impression tray 30.

Continuing with reference to the embodiments of FIGS. 7A to 7C, provision is additionally made in a preferred embodiment for the base area 16 and/or the walls 20 and/or 22 to be mirrored at least in part on the inner side 50. Irradiated or emitted light is therefore reflected by the walls 20, 22 and/or the base area 16 rather than being absorbed. Hence the resultant amount of light available for the measurements is greater, increasing the accuracy. However, what is important in this case is that unwanted mirroring of the optical elements 42 is omitted because this interferes with the measurement.

FIG. 8 shows another carrier 14 according to the invention, which is similar to the carriers 10 and 12 and detachably attached to an impression tray 46.

The impression tray 56 is comparable to the impression tray 30 illustrated in FIGS. 3 to 5, but it does not have an area 36 for holding the carrier 14. In this exemplary embodiment of FIG. 8, the fastening to the impression tray 56 takes place via a connection end 58, which is comparable to the front 54 of the impression tray 30 and has additional fastening means in accordance with the explanations made above in respect of the area 36.

In contrast to all previous illustrations of the carriers 10 and 12, the carrier 14 in FIG. 8 can be seen from underneath. Here, it is possible to see that illumination means 48 are arranged in the base area 60. These illumination means 48 are connected via actuation lines 62 to one another and/or to a control and power supply (not shown in any more detail here). These can be arranged both in the carrier 14 and in the impression tray 56. In the latter case, the connection between the actuation line 62 with the control in the impression tray 56 takes place via a connection point (not shown in any more detail here) in the connection end 58, for example a plug-in connection.

The illumination means 48, which are illustrated here as circular objects, can preferably be LEDs, or else OLEDs, laser LEDs or combinations of these. A further preferred embodiment also provides for embodying the illumination means 48 as chemiluminescent elements, both on their own and in combination with the aforementioned illumination means.

In addition to the embodiment shown in FIG. 8, in which the illumination means 48 are arranged in the base area 60 of the carrier 14, provision is likewise made within the scope of this invention for the illumination means to be arranged either in an outwardly lying wall 64 and/or an inwardly lying wall 66, as well as both in the walls 64 and/or 66 and in the base area 60.

So that the light emitted by the illumination means 48, in accordance with the illustration for the carriers 10 and 12, also impinges on the teeth of the dentition of the patient arranged on the inner side 50 or on the impression material 28, the exit openings of the illumination means 48 must be arranged on the inner side 50. As an alternative to this, it would also be possible for the light of the illumination means 48 to pass through corresponding optical elements 40, such as e.g. optical fibers, lenses, filters or combinations of these, which are situated on the inner side 50. In a further alternative embodiment it would also be feasible for the material of the carrier 14, or of the carriers 10 and 12, to have a transparent design.

Acrylate polymers, preferably polymethyl methacrylate (PMMA), should be mentioned as a preferred option for this. As a result of this, the corresponding light of the illumination means 48 could emerge through this if the latter are arranged in the carrier 14 or on the outer side 67 thereof.

In addition to the appropriate material selection, provision is furthermore made within the scope of the present invention for the carriers 10, 12 and 14 to be preferably embodied as injection-molded parts. As a result, a corresponding industrial production is made possible.

Since use is often made of silicone-based impression materials 28 when the impression material 28 is used in the corresponding carriers 10, 12 and 14, the carriers 10, 12 and 14 are, in a preferred embodiment, provided with a surface 68 on their inner side 50, see FIG. 1, which has increased adherence to silicone. This prevents the impression material 28 from inadvertently detaching from the carrier 10 or 12.

In one embodiment, the carriers 10, 12 and 14, shown above, can be embodied as repeatedly reusable objects. However, by contrast, they can preferably also be designed for single use.

The latter preferred embodiment is advantageous in that the manufacturer can already fill carriers 10, 12 or 14 with an impression material 28 so that the latter, as already explained above, is free from non-uniformity and unwanted inclusions. The customer, i.e. the dentist or the dental technician, can then, according to the invention, use the carriers with a corresponding impression tray 30 or 56 and simply dispose of them after obtaining the corresponding impression data. Cleaning and disinfecting, which are time-consuming and costly, are dispensed with.

Building thereon, yet a further preferred embodiment also comes into consideration, in which the producer already produces a complete set of impression tray 30 or 56, carrier 10, 12 or 14 and impression material 28 as its own embodiment.

The latter can then likewise be supplied to the dentist or dental technician, who can then likewise dispose of this after use or, in view of the electronics contained therein, return it to the producer within the scope of a recycling program.

Within the scope of this invention, such a recycling program would also be feasible for the above-described carriers 10, 12 or 14 with the impression material 28.

What is claimed is:

1. A carrier for a dental impression material for insertion into an impression tray or attachment to a holding device, having a base area which replicates the human jaw and is delimited on two opposing sides by walls in order to form an approximately U-shaped cross section, wherein at least one optical element is arranged in said base area and/or said walls.

2. The carrier of claim 1, wherein a multiplicity of optical elements are arranged in said base area and/or said walls.

3. The carrier of claim 1, wherein said optical elements are selected from lenses, optical fibers, filters and combinations thereof.

4. The carrier of claim 1, wherein said optical elements furthermore comprise electronic sensors.

5. The carrier of claim 4, comprising at least one plug-in connection for transmitting data to a storage unit or a processing unit.

6. The carrier of claim 1, wherein, further, at least one illumination element is arranged in said base area and/or said walls.

7. The carrier of claim 6, wherein said at least one illumination element is selected from chemiluminescent elements, LEDs, OLEDs, laser LEDs and combinations thereof.

8. The carrier of claim 1, wherein said carrier has a surface on an inner side thereof, which exhibits increased adherence to silicones.

9. The carrier of claim 1, consisting of an acrylate polymer, preferably polymethyl methacrylate.

10. The carrier of claim 1, embodied as an injection-molded part.

11. The carrier of claim 1, comprising fastening means for fastening to an impression tray.

12. The carrier of claim 1, wherein said base area and/or said walls are at least partly mirrored on the inner side, with said at least one optical element not being mirrored.

13. The carrier of claim 1, further comprising a dental impression material, which is at least partly filled into a space defined by said walls and said base area.

14. The carrier of claim 13, wherein said impression material comprises at least one luminescent material.

15. The carrier of claim 13, wherein said impression material is a curable impression material.

16. The carrier of claim 15, wherein said impression material is at least partly cured in a region of said walls and/or said base area.

17. The carrier of claim 1, designed for single use.
